(19) United States
(12) Patent Application Publication
(10) Pub. No.: US 2026/0032375 A1
(43) Pub. Date: Jan. 29, 2026

(54) EARPHONE WITH ARRAY FREQUENCY MULTIPLICATION SPEAKER

(71) Applicant: DONGGUAN SHIWEI ELECTRONIC TECHNOLOGY CO., LTD., Dongguan (CN)

(72) Inventors: KEQIANG LI, Dongguan (CN); YONGXIANG ZOU, Dongguan (CN)

(21) Appl. No.: 18/804,289

(22) Filed: Aug. 14, 2024

(30) Foreign Application Priority Data
Jul. 25, 2024 (CN) 202421765580.9

(51) Int. Cl. H04R 1/24; H04R 1/10

(52) U.S. Cl. CPC H04R 1/24; H04R 1/1008; H04R 1/1041; H04R 1/1075; H04R 1/1083; H04R 2400/11

(57) ABSTRACT

An earphone with array frequency multiplication speaker is provided, which includes an outer shell, a center of an inner side of the outer shell is provided with a hollow mounting seat. An inner side of the hollow mounting seat is provided with a large dynamic coil for expressing middle and low frequencies. A center of an upper of the hollow mounting seat is provided with a noise reduction microphone, the upper of the hollow mounting seat is provided with a plurality of speaker units located at an outside the noise reduction microphone. The plurality of multiple speaker units are arranged in an annular array with the noise reduction microphone as an axis, so as to enhance an overall sound performance of the earphone and better reflect a depth of the sound, this earphone has a wide frequency response range, clear and natural sound quality, smooth response frequency.

### CROSS-REFERENCE TO RELATED APPLICATIONS

This application claims priority to Chinese Patent Application No. 202421765580.9, filed on July 25, 2024, which is hereby incorporated by reference in its entirety.

### TECHNICAL FIELD

The present disclosure relates to the field of earphone technologies, and in particular, to an earphone with array frequency multiplication speaker.

### BACKGROUND

Most of the existing ordinary large headphones or noise reduction large headphones are a large dynamic coil speaker, which has strong performance in mid-bass, but lacks performance in mid to high, high, and ultra-high bass. There are also some ordinary large headphones that have a large dynamic coil speaker and a high-frequency dynamic coil speaker, compensating for high frequencies with high-frequency dynamic coils. However, if the large dynamic coil speaker (with mid to low frequency performance) and the high-frequency dynamic coil speaker are not located on the same axis, there may be a left-right difference in sound performance. Therefore, the present application proposes an earphone with array frequency multiplication speaker.

### SUMMARY

In view of this, it is necessary to provide an earphone with array frequency multiplication speaker to address the above technical issues. Through an overall structural design, it can enhance an overall sound performance, better reflect a depth of the sound, and ensure that there is no left-right difference in sound performance.

In order to solve the above technical problems, the present disclosure adopts the following technical solution.

An earphone with array frequency multiplication speaker, including an outer shell, a center of an inner side of the outer shell is provided with a hollow mounting seat, an inner side of the hollow mounting seat is provided with a large dynamic coil configured to express middle and low frequencies, a center of an upper of the hollow mounting seat is provided with a noise reduction microphone, and the upper of the hollow mounting seat is provided with a speaker unit located at an outer side of the noise reduction microphone.

In an embodiment of the present disclosure, the speaker unit is any one or more of a high-frequency dynamic coil speaker, a high-frequency flat speaker, and a ceramic piezoelectric speaker.

In an embodiment of the present disclosure, there are a plurality of speaker units, and the plurality of speaker units are arranged in an annular array.

In an embodiment of the present disclosure, an upper of the outer shell is fixed with an earmuff.

In an embodiment of the present disclosure, the earmuff is made of foam material.

In an embodiment of the present disclosure, a connection bracket is provided on an outer side of the outer shell.

In an embodiment of the present disclosure, the outer side of the outer shell is further provided with a volume button and a power button, respectively.

Compared with existing technologies, the present disclosure has the following beneficial effects.

The earphone with array frequency multiplication speaker provided by the present disclosure, by arranging the plurality of speaker units as an annular array with the noise reduction microphone as the axis, which can render an overall sound performance of the earphone stronger, better reflect a depth of the sound, and the sound performance will not have a left-right difference. The speaker units are any one or more of the high-frequency dynamic coil speaker, high-frequency flat speaker, and ceramic piezoelectric speaker, so that the earphone has a wide frequency response range, clear and natural sound quality, smooth response frequency, high-quality sound, and excellent flexibility, good resolution, and can fully express the charm of music.

### BRIEF DESCRIPTION OF DRAWINGS

In order to provide a clearer explanation of the solution in the present disclosure, a brief introduction will be given to the accompanying drawings required for the description of the embodiments. It is obvious that the accompanying drawings in the following description are some embodiments of the present disclosure. For those skilled in the art, other drawings can be obtained based on these drawings without creative work.

FIG. 1 is a schematic diagram of an overall structure of an earphone with array frequency multiplication speaker provided by the present disclosure.

FIG. 2 is an exploded view of an overall structure of the earphone with array frequency multiplication speaker provided by the present disclosure.

FIG. 3 is a schematic diagram of an inner structure of an outer shell of the earphone with array frequency multiplication speaker provided by the present disclosure.

Numeral reference: 1-outer shell; 2-earmuff; 3-hollow mounting seat; 4-noise reduction microphone; 5-large dynamic coil; 6-speaker unit.

### DESCRIPTION OF EMBODIMENTS

As described in the background technology, large dynamic speaker has strong performance in mid-bass, but lacks performance in mid to high, high, and ultra-high bass. There are also some ordinary large headphones that have a large dynamic coil speaker and a high-frequency dynamic coil speaker, compensating for high frequencies with high-frequency dynamic coils. However, if the large dynamic coil speaker (with mid to low frequency performance) and the high-frequency dynamic coil speaker are not located on the same axis, there may be a left-right difference in sound performance.

In order to solve this technical problem, the present disclosure provides an earphone with array frequency multiplication speaker, which includes an outer shell 1, a center of an inner side of the outer shell 1 is provided with a hollow mounting seat 3. An inner side of the hollow mounting seat 3 is provided with a large dynamic coil 5 configured to express middle and low frequencies. A center of an upper of the hollow mounting seat 3 is provided with a noise reduction microphone 4, and the upper of the hollow mounting seat 3 is provided with a spearer unit 6 located at an outer side of the noise reduction microphone 4.

The earphone with array frequency multiplication speaker provided by the present disclosure, by arranging the plurality of speaker units 6 as an annular array with the noise reduction microphone 4 as the axis, which can render an overall sound performance of the earphone stronger, better reflect a depth of the sound, and the sound performance will not have any left-right difference. The speaker units 6 are any one or more of the high-frequency dynamic coil speaker, high-frequency flat speaker, and ceramic piezoelectric speaker, so that the earphone has a wide frequency response range, clear and natural sound quality, smooth response frequency, high-quality sound, and excellent flexibility, good resolution, and can fully express the charm of music.

It should be noted that, without conflict, the embodiments and features and technical solutions in the present disclosure can be combined with each other.

It should be noted that similar labels and letters represent similar member in the following drawings. Therefore, once a member is defined in one drawing, it does not need to be further defined and explained in subsequent drawings.

### Embodiment 1:

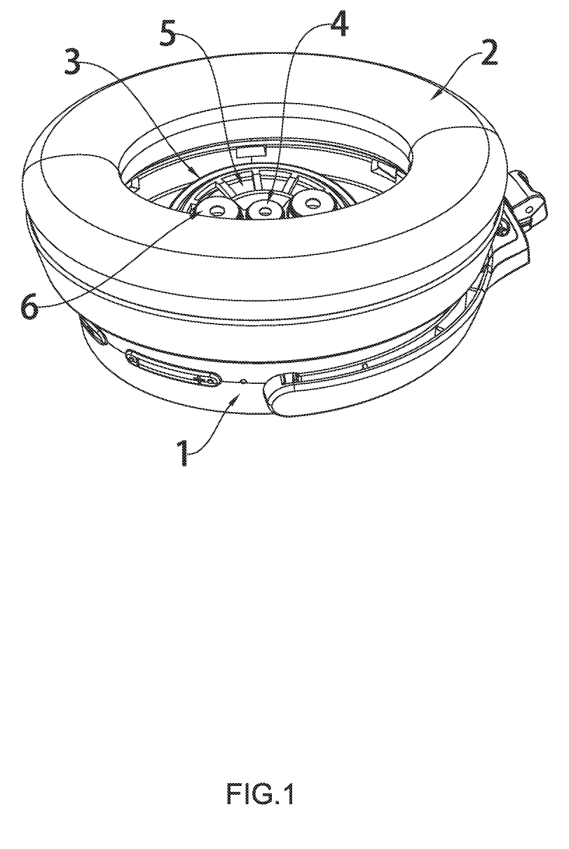

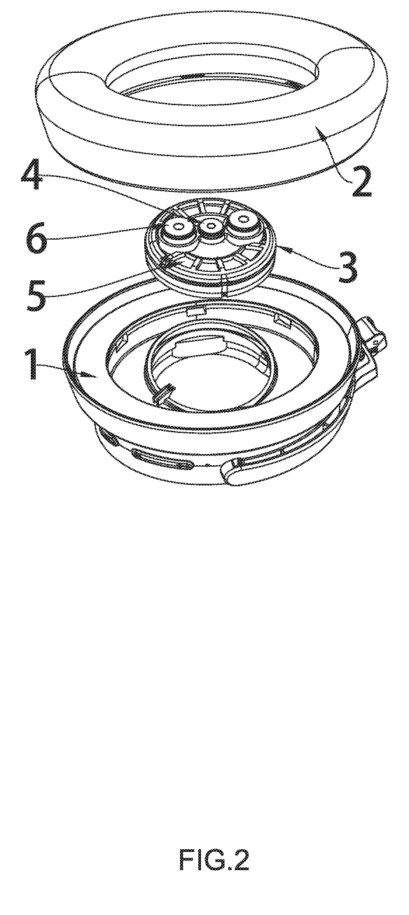

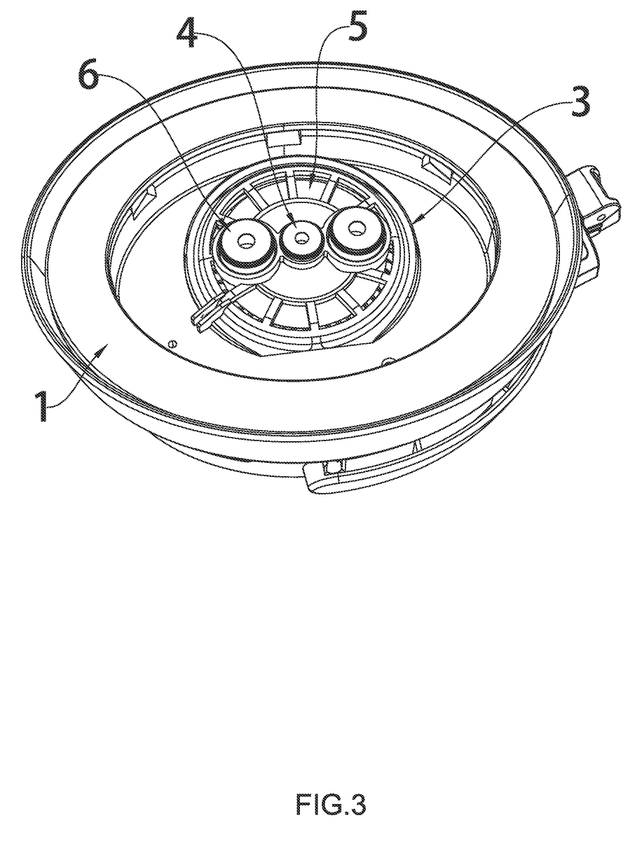

Please refer to FIGS. 1-3, an earphone with array frequency multiplication speaker includes an outer shell 1. An outer side of the outer shell 1 is provided with a connection bracket for mounting and fixing with a head mounted bracket. The outer side of the outer shell 1 is further provided with a volume button and a power button, respectively. An upper of the outer shell 1 is fixed with an earmuff 2, which is made of foam material. A hollow mounting seat 3 is fixed at a center of an inner side of the outer shell 1.

An inner side of the hollow mounting seat 3 is provided with a large dynamic coil 5 configured to express middle and low frequencies, which has the characteristics of soft sound, high power, good bass effect, and wide frequency response. A noise reduction microphone 4 is provided at a center of an upper of the hollow mounting seat 3 and is coaxially arranged with the large dynamic coil 5. A speaker unit 6 is provided at the upper of the hollow mounting seat 3 and on an outer side of the noise reduction microphone 4. Through the speaker unit 6, an overall sound expression of this earphone can be stronger, and the depth of the sound can be better reflected.

### Embodiment 2:

Based on Embodiment 1, there are a plurality of speaker units 6, and the plurality of speaker units 6 are any one or more of a high-frequency dynamic coil speaker, a high-frequency flat panel speaker, and a ceramic piezoelectric speaker. The plurality of speaker units 6 are arranged in an annular array with the noise reduction microphone 4 as the axis. The high-frequency flat panel speaker has excellent flexibility, good resolution, and can fully express the charm of music, while the ceramic piezoelectric speaker has a wide frequency response range, clear and natural sound quality, smooth response frequency, and high-quality sound.

### Embodiment 3:

When this earphone is a noise reduction microphone, the setting of the noise reduction microphone 4 plays a role in noise reduction. When this earphone is a regular earphone, the noise reduction microphone 4 can be replaced with a regular high-frequency speaker.

What is claimed is:

1. An earphone with array frequency multiplication speaker, comprising an outer shell, a center of an inner side of the outer shell is provided with a hollow mounting seat, an inner side of the hollow mounting seat is provided with a large dynamic coil configured to express middle and low frequencies, a center of an upper of the hollow mounting seat is provided with a noise reduction microphone, and the upper of the hollow mounting seat is provided with a speaker unit located at an outer side of the noise reduction microphone.

2. The earphone with array frequency multiplication speaker according to claim 1, wherein the speaker unit is any one or more of a high-frequency dynamic coil speaker, a high-frequency flat speaker, and a ceramic piezoelectric speaker.

3. The earphone with array frequency multiplication speaker according to claim 2, wherein there are a plurality of speaker units, and the plurality of speaker units are arranged in an annular array.

4. The earphone with array frequency multiplication speaker according to claim 1, wherein an upper of the outer shell is fixed with an earmuff.

5. The earphone with array frequency multiplication speaker according to claim 4, wherein the earmuff is made of foam material.

6. The earphone with array frequency multiplication speaker according to claim 1, wherein a connection bracket is provided on an outer side of the outer shell.

7. The earphone with array frequency multiplication speaker according to claim 1, wherein an outer side of the outer shell is further provided with a volume button and a power button, respectively.
